(19) United States
(12) Patent Application Publication
(10) Pub. No.: US 2015/0134496 A1
(43) Pub. Date: May 14, 2015

(54) METHOD FOR PROVIDING FOR THE REMOTE FITTING AND/OR SELECTION OF CLOTHING

(71) Applicants: Alina Olegovna Grinblat, Moscow (RU); Vagan lshkhanovich Martirosian, Moscow (RU)

(72) Inventors: Alina Olegovna Grinblat, Moscow (RU); Vagan lshkhanovich Martirosian, Moscow (RU)

(73) Assignee: Dressformer, Inc., Dover, DE (US)

(21) Appl. No.: 14/577,213

(22) Filed: Dec. 19, 2014

Related U.S. Application Data
(63) Continuation of application No. PCT/RU2013/000586, filed on Jul. 9, 2013.

(30) Foreign Application Priority Data
Oct. 7, 2012 (RU) 2012128687/08

(51) Int. Cl. G06Q 30/06; G06K 9/00; G06T 19/00

(52) U.S. Cl. CPC G06Q 30/0643; G06T 19/00; G06K 9/00208; G06T 2200/24; G06T 2210/16
USPC 705/27.2

(57) ABSTRACT

The invention disclosed herein involves a method of facilitating remote fitting and/or selection of clothes, includes setting up and maintaining a website; creating a database of clothing items; with the use of a photo panel made of flexible material, provided with a graphic marking, and a photographic camera obtaining at least two photographs of different sides of one clothing item; selecting, on the photograph, contours of the clothing item as well as the type, shape and dimensions of parts of the clothing item; building or finding in the database of clothing items a similar three-dimensional model of a clothing item using said template of the clothing item and the photographs of the clothing item taken; developing a three dimensional model of the body of the consumer using a template of a human body, and selecting the clothing item corresponding to the obtained three-dimensional model of the body of the consumer.

### CROSS REFERENCE TO RELATED APPLICATIONS

This application is a continuation application which claims priority to International Application No. PCT/RU2013/000586 filed on Jul. 9, 2013, which in turn claims priority to Russian Patent Application RU 2504009 filed on Jul. 10, 2012.

### BACKGROUND OF THE INVENTION

1. Field of the Invention

The invention relates to the sale of products of garment, knitwear and footwear industries.

2. Description of Related Art

With reference to application EA 200970864 published 30 Apr. 2010, there is known a method that provides remote ordering of garments by a consumer, in accordance with actual body dimensions of a consumer. When exercising the method known from EA 200970864, a picture of a consumer's body is taken, a three-dimensional model of a consumer's body of is built, which is used for obtaining measurements for further tailoring. The measurements for clothes, obtained as described above, are used to regulate manageable tailor's dummy, which is used for clothes fabrication in accordance with real anatomical features of a consumer's body. For communication between the site for constructing three-dimensional model of a consumer and a site of tailoring using a manageable tailor's dummy, the Internet is used. With reference to an application U.S. 2011298897 published Aug. 12, 2011, there is known an Internet-based technology for remote selection by a user of ready-made clothes, in accordance with its own anatomical parameters. This technology is based on matching of three-dimensional models of clothing items and three dimensional model of a consumer's body.

### SUMMARY OF THE INVENTION

The subject matter of this application may involve, in some cases, interrelated products, alternative solutions to a particular problem, and/or a plurality of different uses of a single system or article.

In turn, the invention should be considered as further development of the described above technologies of ordering and selection of clothing items, the ultimate goal of which should be an improvement of quality of technology for ordering items of clothing, footwear and headwear. According to the goal, the technical effect achieved by the use of this method is to minimize errors occurring at remote ordering of items of clothes, footwear, hats, and also an expansion of the list of technical means used in the technologies of remote ordering of clothes.

The above technical effect is achieved by using a method of remote fitting and/or selection, the basis of which is setting-up and support of at least one web-site on at least one web server. On the basis of computer storage media associated with the web server through the Internet, at least one database of clothing items is arranged, in creation and/or utilization of which a library of three dimensional templates that are changeable depending on the size and/or type of material is formed. The database also comprises a library of changeable three-dimensional templates of a human body. A part of the formation of this database further includes using a photo panel made of flexible material, provided with a graphic marking and a photographic camera, at least two pictures of different sides of one item of clothing are received, mainly its front and back side. On the photograph, contours of the clothing item as well as the type, shape and geometric dimensions of component parts of the clothing item are selected. Eventually, a three dimensional model of the clothing item is built using the garment template and the obtained images of the clothing item, and the received three-dimensional model of the clothing item is provided with information required for fitting and, mainly characterizing its type, size, color, and/or trade name.

For remote fitting and/or selection of clothes, interaction of the customer with the web server is provided through a customer application for fitting and/or selection of clothing. A customer application can be a web-site designed specifically to be used for implementing the method, or an application of any social network. First of all, data is inserted on the parameters of a consumer body selected from a list that includes at least: height, chest circumference, waist line circumference, hip circumference, hip height, leg length, arm length, underbust circumference, shoulder circumference, shoulder length, neck circumference, shoulder breadth, length of back till waist line, breast center, length of the front till waist line, breast height, back breadth, calf circumference. These settings can be selected on the basis of measurements of a consumer's body of or be determined by his/her pictures. Then a three dimensional model of the consumer's body is built using a three-dimensional pattern of the human body, corresponding to the settings specified. Information on the garment parameters required by the consumer is inserted, availability of the mentioned three-dimensional models of a clothing item is determined corresponding to the received three-dimensional model of the body of the consumer; if at least one required three-dimensional model of the clothing item is available, then at least one clothing item, corresponding to the obtained three-dimensional model of the customer's body, is selected.

The invention relates to the sale of products of garment, knitwear and footwear industries, namely to remotely order clothing items corresponding to actual body features of the customer. The technical effect is an increase in accuracy of remote ordering clothing items corresponding to actual body features of the customer. The method of facilitating remote fitting and/or selection of clothes, includes setting up and maintaining at least one website; creating a database of clothing items; with the use of a photo panel made of flexible material, provided with a graphic marking, and a photographic camera obtaining at least two photographs of different sides of one clothing item, mainly its front side and back side; selecting, on the photograph, contours of the clothing item as well as the type, shape and geometric dimensions of component parts of the clothing item; building or finding in the database of clothing items a similar three-dimensional model of a clothing item using said template of the clothing item and the photographs of the clothing item taken; facilitating the interaction of the consumer with a web server, during which a three dimensional model of the body of the consumer is constructed using a predetermined three-dimensional template of a human body, and selecting the clothing item corresponding to the obtained three-dimensional model of the body of the consumer.

Additionally, through the web-sites at least one message with recommendations for selection of clothing items is displayed.

### BRIEF DESCRIPTION OF THE DRAWINGS

The proposed invention is illustrated by the following images:

FIG. 1—block diagram of how to provide remote fitting and/or choice of clothing.

FIG. 2—getting photos of garments on the photo panel.

FIG. 3—putting a picture of a clothing item in the clothing items database.

FIG. 4—obtaining parameters of a consumer's body.

FIG. 5—placing the parameters of a consumer's body on the web-site.

FIG. 6—fitting of garments on the web site.

### DETAILED DESCRIPTION

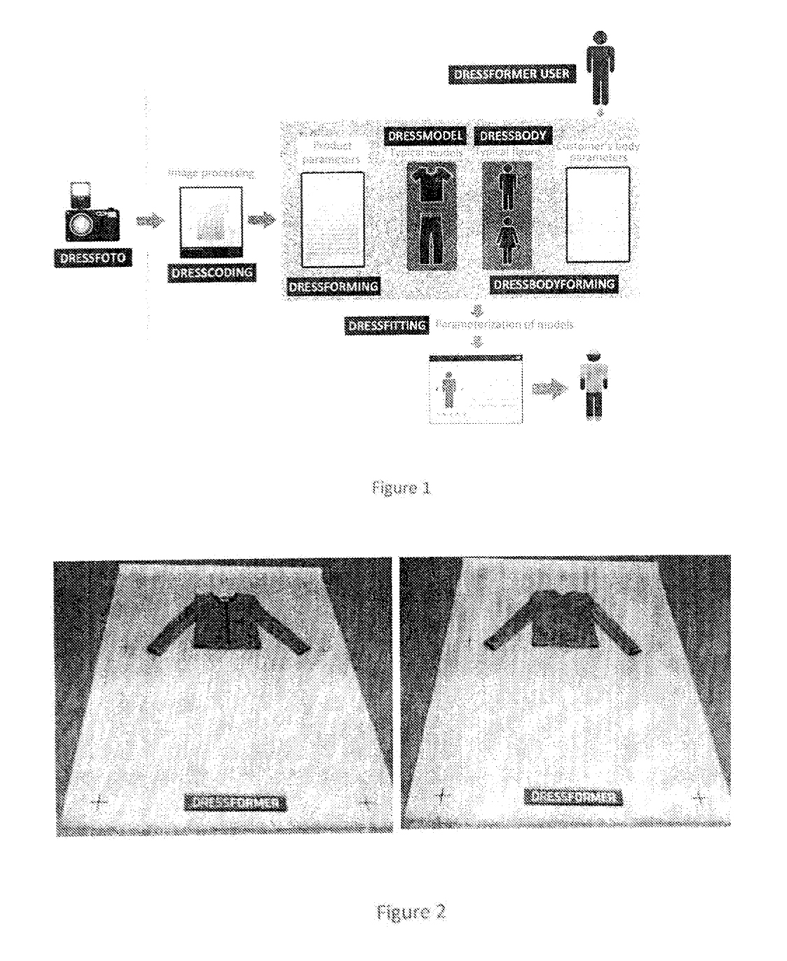

At practical implementation of the proposed method (FIG. 1), one or more web sites are created, with the help of which customers ordering clothing items can make orders for necessary items, i.e. an e-commerce web site is created. A web site is maintained by a web server/the complex web servers, which provide control over the implementation of the proposed method. Moreover, it should be noted that in such case the term “clothes/clothing item” also means shoes, hats, and other products. The clothes fitting service can be run through an independent site created for this purpose, or an application of any social network or private online store website. When working with previously used web-site, a separate page/account for remote fitting and/or selection of clothes is created. A web-server, providing operation of the specified site, in its turn, is used to interact with a database of various clothing items, fitting and selection of which is provided in the implementation of the proposed method.

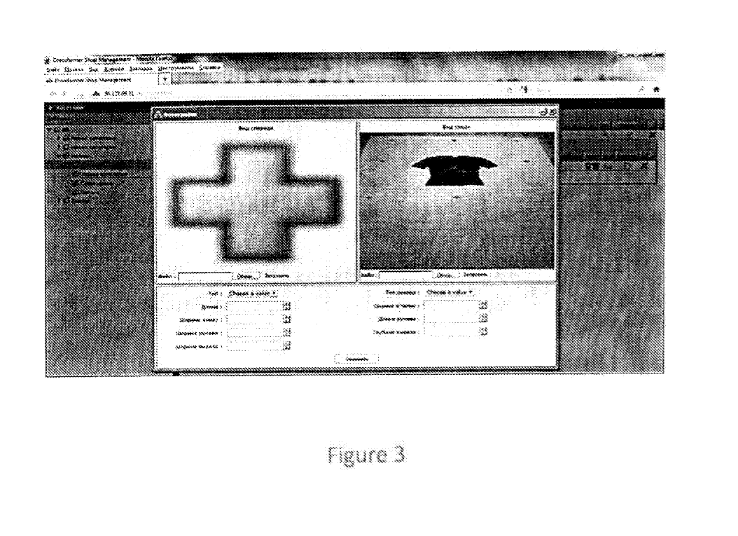

The clothes database is based on a pre-defined library of three-dimensional templates of clothing items changeable depending on the size and/or type of material and a library of three-dimensional templates of a human body. The use of these templates, on one hand, will help to build models of actual clothing items and bodies of consumers, and on the other hand will allow use of a new method of remote fitting of clothes—three-dimensional templates. This database is filled and further is dynamically updated with three-dimensional models of clothing items. The basis for building three-dimensional models of a clothing item is a photo of a clothing item taken from several sides, e.g. the front and back sides of a flat clothing item. A photo is taken on a photo panel made of flexible material and equipped with a graphics markup that displays the grid, contours of the human body etc., as shown in FIG. 2, and FIG. 3. The known dimensions of the photo panel, coupled with the grid (shown as six ‘+’ shapes in FIG. 2) ensures proper proportioning when loading the image and clothing item information to the database. Further, the dimensions, contours, and other information of the clothing item can be automatically determined by the computer based on the dimensions of the photo panel, coupled with the grid. Obtaining of the image in this way will allow for avoiding possible errors in recognition of the obtained image and, respectively, in standardization for further building of models. Further, in recognition of the image contours of the clothing item, as well as type, form and size of the constituent elements of the clothing item, are outlined in the photo. As a result, for each clothing item a three-dimensional model of such clothing item is built with the use of the predefined garment template, by means of its morphing and the received images of the clothing item, the given three-dimensional model of the clothing item is provided with information required for its fitting, for example, the characteristics of type, size, color, trade name, etc. Thus, the three-dimensional model of the clothing item is received that most accurately reflects the actual physical properties of the clothes.

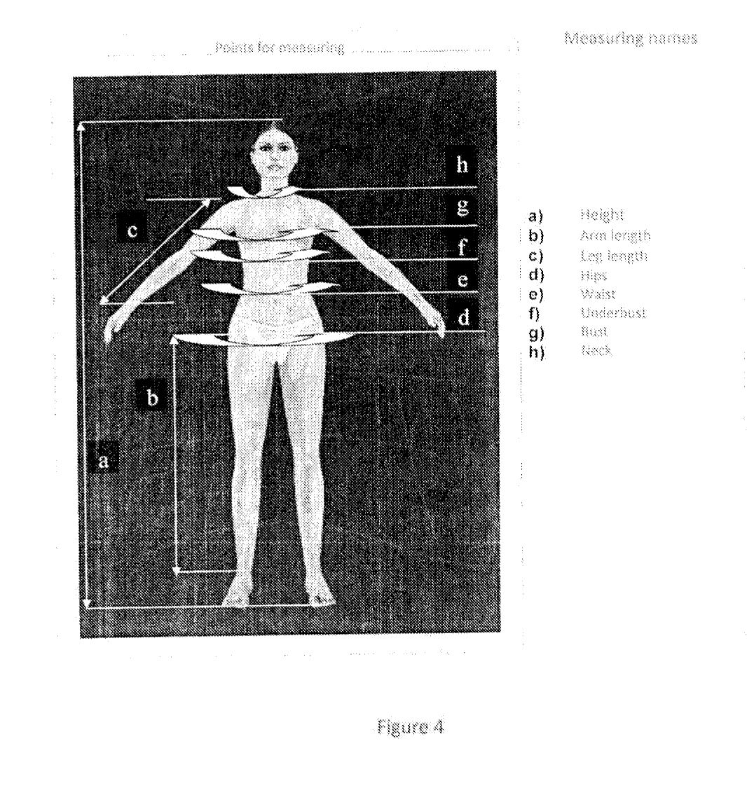

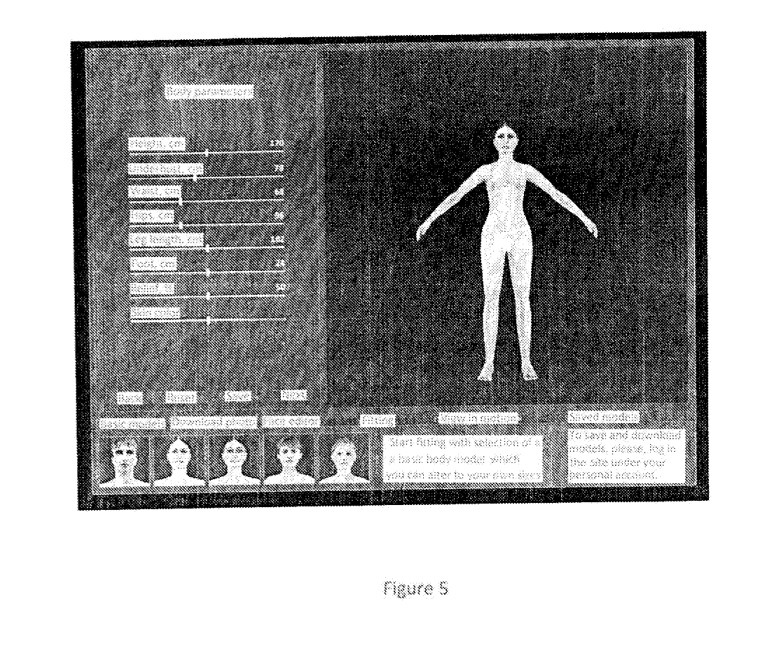

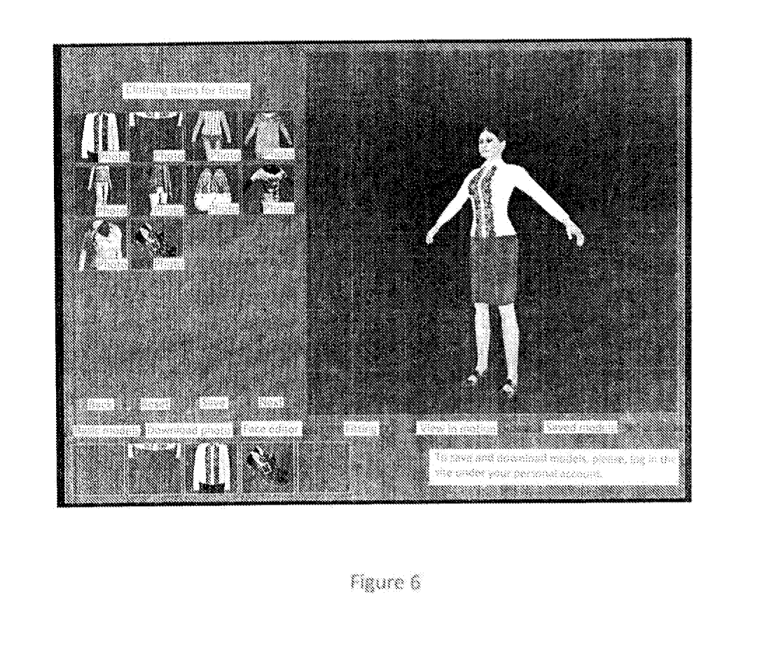

To order the necessary and favorite clothes, a consumer visits the web site described above. For work and interaction with the site, a consumer may be offered to use a well-known technology of working with the site—creating a personal account. Based on the measurements of the real body of the consumer as shown in FIG. 4 or data form recognition of his/her pictures, via the web-site interface, information on the parameters of the body of the consumer is sent to the web server. These settings are chosen from the list that includes, at least, height, chest circumference, waist line circumference, hip circumference, hip height, leg length, arm length, underbust circumference, shoulder circumference, shoulder length, neck circumference, shoulder breadth, length of back till waist line, breast center, length of the front till waist line, breast height, back breadth, calf circumference as seen in FIG. 4, and FIG. 5. A specific list of settings for the body of a consumer can vary based on the features of a number of clothing items of, remote fitting and the choice of which will ensure the proposed method. However, the above-mentioned parameters provide, on the one hand, its easy determination by a user and, on the other hand, allow for building an accurate three dimensional model of the human body without the analysis of a number of pictures of the body, taken from different angles. As a result, a three-dimensional model of the body of the consumer is built, using morphing of the above determined three-dimensional pattern of the human body, most closely corresponding to the settings specified.

Thus, the three-dimensional model of his/her body and web site interface of interaction with dynamically updated clothing items database is available for the customer of the clothing item. By inserting data on the clothing item required by him/her, the customer may determine whether such clothing items are available in the database, whether an appropriate size, color, fabric, etc. is available. If the clothing items of interest are available, fitting as seen in FIG. 6 and further order of the required clothing item is carried out. It follows that interaction with three dimensional models of the human body and parameters of clothing item, on the one hand, accurately reflecting feature of a real object and, on the other hand, obtained by simple actions, will provide for accurate and high quality remote ordering of clothing items.

Thus, the method of remote fitting and/or selection of clothes, which will improve the quality and accuracy of ordering of clothing items suitable for actual body features of a customer.

1. A method of facilitating remote fitting and/or selection of clothes, including:
setting up and maintaining at least one web-site based on at least one web-server;
creating, based on computer data storage media connected to the said web-server through the Internet, at least one data base of three-dimensional models of clothing items, the creating comprising the steps of:
forming a library of three-dimensional templates of clothes changeable depending on size and/or type of material,
forming a library of three-dimensional templates of human bodies of both genders and constitution types,
with the use of a photo panel made of flexible material, provided with a graphic marking, and a photographic camera, obtaining at least two photographs of different sides of one clothing item, mainly its front side and back side with the clothing item placed on the photo panel for reference during the step of obtaining the at least two photographs,
selecting on the photograph contours of a clothing item as well as type, shape and geometric dimensions of component parts of the clothing item using a computer,
finding in a database of clothing items a similar three-dimensional model of a clothing item using said template of the clothing item and the photographs of the clothing item taken;
providing the obtained three-dimensional model of the clothing item with the data necessary for its fitting and characterizing at least one of its type, size, color and brand name;
facilitating the interaction of a consumer with the web—server through the web-site—for fitting and/or selection of clothes, the facilitating comprising the steps of:
receiving an input of data on a customer's body dimensions chosen from dimensions which include, at least: height, chest circumference, waist line circumference, hip circumference, hip height, leg length, arm length, underbust circumference, shoulder circumference, shoulder length, neck circumference, shoulder breadth, length of back till waist line, breast center, length of the front till waist line, breast height, back breadth, calf circumference,
building a three-dimensional model of the body of the consumer with the use of a predetermined three-dimensional template of a human body, corresponding to the input data,
receiving input of data on the clothing items required by the customer,
determining the availability of the said three-dimensional models of the clothing items corresponding to the obtained customer's body three-dimensional model,
selecting at least one clothing item, corresponding to the obtained three-dimensional model of the customer's body if at least one required three-dimensional model of the clothing item is available, then.

2. The method according to claim 1 wherein the web site is organized with the use of client application, which ensures its implementation in the form of social network applications, mobile or desktop application.

3. The method according to claim 1 wherein the input data are numerical data.

4. The method according to claim 1 wherein the body parameters of a consumer is determined by a photograph of the consumer, automatically, using the computer.

5. The method according to claim 1 further comprising the step of displaying to the consumer at least one message comprising recommendations for selection of clothing items.

6. The method according to claim 1, further comprising the step of displaying to the consumer a three-dimensional view of the consumer, dressed in several items of clothing, rotatable and scalable in real-time, by receiving an input from the consumer.

7. The method according to claim 1 wherein the photo panel is formed of a flexible material of a predetermined size, the predetermined size previously input into the computer, the photo panel further comprises a grid comprising six marks defining a perimeter of a clothing item area on the photo panel; the step of obtaining at least two photographs further comprising the step of placing the clothing item within the clothing item area.
